(19) United States
(12) Patent Application Publication
(10) Pub. No.: US 2026/0342259 A1
(43) Pub. Date: Oct. 29, 2026

(54) POWER SUPPLY MODULATION SYSTEM, A BRUSHLESS ELECTRIC TOOL AND A CONTROL METHOD THEREOF, AND A BRUSHLESS MOTOR CONTROL SYSTEM AND A CONTROL METHOD THEREOF

(71) Applicant: Nanjing Magtek Power System Co., Ltd., Jiangsu (CN)

(72) Inventors: Shibo CHEN, Jiangsu (CN); Xiaohui SU, Jiangsu (CN)

(73) Assignee: Nanjing Magtek Power System Co., Ltd., Jiangsu (CN)

(21) Appl. No.: 19/708,738

(22) Filed: Jun. 15, 2026

Related U.S. Application Data
(63) Continuation of application No. PCT/CN2025/086222, filed on Mar. 31, 2025.

(30) Foreign Application Priority Data
Jan. 9, 2025 (CN) 202510039576.7
Mar. 24, 2025 (CN) 202510349179.X

(51) Int. Cl. H02P 23/26

(52) U.S. Cl. CPC H02P 23/26

(57) ABSTRACT

The present application proposes a power supply modulation system, comprising: a rectifier unit and a power factor correcting unit, wherein the rectifier unit has a first input terminal, a second input terminal, a first output terminal, and a second output terminal, the first input terminal and the second input terminal are connected to an alternating current (AC) power grid the power factor correcting unit comprises a first capacitive element, a second capacitive element, a first diode element, a first switching element, and a second switching element, the first capacitive element and the first switching element are connected in series between the first output terminal and the second output terminal; the second capacitive element and the second switching element are connected in series between the first output terminal and the second output terminal; the first diode element is connected in series between the first capacitive element and the second capacitive element.

### CROSS-REFERENCE TO RELATED APPLICATION

This application is a continuation of International Application No. PCT/CN2025/086222, filed on Mar. 31, 2025, which claims priority to Chinese patent applications No. 202510039576.7, entitled “A POWER SUPPLY MODULATION SYSTEM, A BRUSHLESS ELECTRIC TOOL AND A CONTROL METHOD THEREOF”, filed on Jan. 9, 2025, and No. 202510349179.X, entitled “A POWER SUPPLY MODULATION SYSTEM, A BRUSHLESS ELECTRIC TOOL AND A CONTROL METHOD THEREOF, AND BRUSHLESS MOTOR CONTROL SYSTEM AND A CONTROL METHOD THEREOF”, filed on Mar. 24, 2025. The disclosures of the aforementioned applications are hereby incorporated by reference in their entireties.

### BACKGROUND

### Technical Field

The present application relates to a power supply modulation method, and more particularly, to a power supply modulation method for brushless electric tools and a control method for brushless motors.

### Description of Related Art

The power supply system for a high-voltage brushless electric tool always employs a rectifier bridge to rectify and filter alternating current (AC), which is then used as a power supply to power the permanent magnet brushless motor. The rectifier bridge converts one sine-wave AC cycle into a two half-wave direct current (DC), and then a filter capacitor filters the half-wave DC into a nearly constant-amplitude DC, which is transferred to the brushless motor as its power supply voltage.

Currently, traditional power supply systems for high-voltage brushless electric tools connect a filter capacitor in parallel at the output end of the rectifier bridge to filter the two half-wave DC into a nearly constant-amplitude DC. However, the design of the filter capacitor at the output end of the rectifier bridge is one of the challenges for the power supply modulation system. If the capacitance of the filter capacitor at the output end of the rectifier bridge is large, although the motor can operate at full load at any time, with high output torque and high efficiency, this large capacitance will cause the rectifier bridge output current to be a large spike current that charges the capacitor. Consequently, the power factor of the entire power system of the high-voltage brushless electric tool becomes very low. This not only adversely affects the power grid but also makes it difficult for the tool to comply with the safety regulatory requirements for electromagnetic compatibility. If the capacitance of the filter capacitor at the output end of the rectifier bridge is small, the voltage input to the motor will be close to two half-waves with large amplitude oscillation. That is, when the half-wave voltage is high, the motor operates at full load; but when the half-wave voltage is low, the motor output torque is small and the efficiency is low; or even when the back electromotive force at the current operating rotation speed of the motor is higher than the half-wave voltage, the motor no longer outputs torque.

In a circuit, a capacitor serves as an energy storage device. The introduction of a capacitor alters the phase difference between voltage and current, thereby affecting the power factor of the circuit. A decrease in power factor results in the generation of a certain amount of reactive power. When the power factor is high, it indicates a high utilization rate of electrical energy in the circuit and a good quality of power source. This is because a higher power factor means larger actual power and relatively smaller apparent power, i.e. less useless power (such as reactive power) in the circuit. In this way, circuits and devices can operate more efficiently and reduce energy waste, thereby enhancing energy efficiency.

### SUMMARY

The technical problem to be solved in the present application is how to improve the power factor of high-voltage brushless electric tools in a low-cost and effective manner.

To address the aforementioned issues, the present application proposes a power supply modulation system, comprising: a rectifier unit and a power factor correcting unit, wherein the rectifier unit has a first input terminal, a second input terminal, a first output terminal, and a second output terminal, the first input terminal and the second input terminal are used for connecting to an AC power grid, the rectifier unit is used for converting AC power into DC power; a power factor correcting unit is connected in parallel between the first output terminal and the second output terminal; the power factor correcting unit comprises a first capacitive element, a second capacitive element, a first diode element, a first switching element, and a second switching element, the first capacitive element and the first switching element are connected in series and connected in parallel between the first output terminal and the second output terminal; the second capacitive element and the second switching element are connected in series and connected in parallel between the first output terminal and the second output terminal; the first diode element is connected in series between the first capacitive element and the second capacitive element. The power supply modulation system proposed in the present application effectively improves the power factor during high-speed operation of the brushless motor, and ensures output torque while reducing copper loss in the motor during low-speed operation of the brushless motor.

Furthermore, the capacitance of the first capacitive element is equal to that of the second capacitive element.

Furthermore, the power factor correcting unit further comprises a second diode element, the first switching element has a first terminal and a second terminal, the second diode element is connected in parallel between the first terminal and the second terminal of the first switching element.

Furthermore, the power factor correcting unit has a first connection state and a second connection state, when the power factor correcting unit is in the first connection state, the first switching element and the second switching element are in an off state; when the power factor correcting unit is in the second connection state, the first switching element and the second switching element are in an on state.

Furthermore, the first capacitive element has a positive terminal and a negative terminal, the second capacitive element has a positive terminal and a negative terminal, the first diode element has a positive terminal and a negative terminal; the positive terminal of the first capacitive element is connected to the first output terminal, the negative terminal of the first capacitive element is connected to one terminal of the first switching element, the other terminal of the first switching element is connected to the second output terminal, the negative terminal of the second capacitive element is connected to the second output terminal, the positive terminal of the second capacitive element is connected to one terminal of the second switching element, the other terminal of the second switching element is connected to the first output terminal, the positive terminal of the first diode element is connected to the negative terminal of the first capacitive element, the negative terminal of the first diode element is connected to the positive terminal of the first capacitive element.

Furthermore, the power factor correcting unit has a first connection state and a second connection state, when the power factor correcting unit is in the first connection state, the first switching element and the second switching element are in an off state or in an on state, based on a sine wave grid angle; when the power factor correcting unit is in the second connection state, the first switching element and the second switching element are in an on state.

Furthermore, a third capacitive element is included. The third capacitive element is connected in parallel between the first output terminal and the second output terminal.

The present application also proposes a brushless electric tool, comprising: a brushless motor, provided with a position sensing unit; a power supply modulation system for providing DC power to the brushless motor; a control unit for providing a control signal to control the brushless motor; a motor driving unit for receiving the control signal from the control unit and sending a drive signal to drive the brushless motor based on the control signal; and a motor switching unit for receiving the drive signal from the motor driving unit and switching the connection between the power supply modulation system and the brushless motor; the power supply modulation system comprises: a rectifier unit and a power factor correcting unit, wherein the rectifier unit has a first input terminal, a second input terminal, a first output terminal, and a second output terminal, the first input terminal and the second input terminal are used for connecting to an AC power grid, the rectifier unit is used for converting AC power into DC power; the power factor correcting unit is connected in parallel between the first output terminal and the second output terminal; the power factor correcting unit comprises a first capacitive element, a second capacitive element, a first diode element, a first switching element, and a second switching element, the first capacitive element and the first switching element are connected in series and connected in parallel between the first output terminal and the second output terminal; the second capacitive element and the second switching element are connected in series and connected in parallel between the first output terminal and the second output terminal; the first diode element is connected in series between the first capacitive element and the second capacitive element.

Furthermore, the power factor correcting unit further comprises a second diode element, the first switching element has a first terminal and a second terminal, the second diode element is connected in parallel between the first terminal and the second terminal of the first switching element.

Furthermore, the power factor correcting unit has a first connection state and a second connection state, when the power factor correcting unit is in the first connection state, the first switching element and the second switching element are in an on state; when the power factor correcting unit is in the second connection state, the first switching element and the second switching element are in an off state.

Furthermore, the brushless motor has a first operating state and a second operating state. When the brushless motor is in the first operating state, the power factor correcting unit is in a first connection state; when the brushless motor is in the second operating state, the power factor correcting unit is in a second connection state. Based on the operating state of the brushless motor, the power supply modulation system switches its working mode, so that the brushless motor exhibits smaller phase current spike during low-speed and high-torque operation, thereby guaranteeing output torque and reducing copper loss in the motor. During high-speed and high-power operation, the brushless motor achieves a high power factor.

Furthermore, the first operating state is a high-speed operating state, the second operating state is a low-speed operating state.

Furthermore, the first capacitive element has a positive terminal and a negative terminal, the second capacitive element has a positive terminal and a negative terminal, the first diode element has a positive terminal and a negative terminal; the positive terminal of the first capacitive element is connected to the first output terminal, the negative terminal of the first capacitive element is connected to one terminal of the first switching element, the other terminal of the first switching element is connected to the second output terminal, the negative terminal of the second capacitive element is connected to the second output terminal, the positive terminal of the second capacitive element is connected to one terminal of the second switching element, the other terminal of the second switching element is connected to the first output terminal, the positive terminal of the first diode element is connected to the negative terminal of the first capacitive element, the negative terminal of the first diode element is connected to the positive terminal of the first capacitive element.

Furthermore, the power factor correcting unit has a first connection state and a second connection state, when the power factor correcting unit is in the first connection state, the first switching element and the second switching element are in an off state or in an on state, based on a sine wave grid angle; when the power factor correcting unit is in the second connection state, the first switching element and the second switching element are in an on state.

Furthermore, the capacitance of the first capacitive element is equal to that of the second capacitive element.

Furthermore, the control unit is also used for controlling the first switching element and the second switching element.

The present application also proposes a control method for a brushless electric tool, the brushless electric tool comprises: a brushless motor and a power supply modulation system for providing DC power to the brushless motor; the power supply modulation system comprises: a rectifier unit and a power factor correcting unit, wherein the rectifier unit has a first input terminal, a second input terminal, a first output terminal, and a second output terminal, the first input terminal and the second input terminal are used for connecting to an AC power grid, the rectifier unit is used for converting AC power into DC power; the power factor correcting unit is connected in parallel between the first output terminal and the second output terminal; the power factor correcting unit comprises a first capacitive element, a second capacitive element, a first diode element, a first switching element, and a second switching element, the first capacitive element and the first switching element are connected in series and connected in parallel between the first output terminal and the second output terminal; the second capacitive element and the second switching element are connected in series and connected in parallel between the first output terminal and the second output terminal; the first diode element is connected in series between the first capacitive element and the second capacitive element; the control method for the brushless electric tool comprises: when the brushless motor is in the first operating state, the first switching element and the second switching element may be turned off; when the brushless motor is in the second operating state, the first switching element and the second switching element may be turned on. Based on the operating state of the brushless motor, the power supply modulation system switches its working mode, so that the brushless motor exhibits smaller phase current spike during low-speed and high-torque operation, thereby guaranteeing output torque and reducing copper loss in the motor. During high-speed and high-power operation, the brushless motor exhibits a high power factor.

Furthermore, the first operating state is a high-speed operating state, the second operating state is a low-speed operating state.

The present application also proposes a brushless motor control system, comprising: a power supply modulation system for providing DC power to a brushless motor; a control unit for providing a control signal to control the brushless motor; a motor driving unit for receiving the control signal from the control unit and sending a drive signal to drive the brushless motor based on the control signal; and a motor switching unit for receiving the drive signal from the motor driving unit and switching the connection between the power supply modulation system and the brushless motor; the power supply modulation system comprising: a rectifier unit and a power factor correcting unit, wherein the rectifier unit has a first input terminal, a second input terminal, a first output terminal, and a second output terminal, the first input terminal and the second input terminal are used for connecting to an AC power grid, the rectifier unit is used for converting AC power into DC power; the power factor correcting unit is connected in parallel between the first output terminal and the second output terminal; the power factor correcting unit comprises a first capacitive element, a second capacitive element, a first diode element, a first switching element, and a second switching element, the first capacitive element and the first switching element are connected in series and connected in parallel between the first output terminal and the second output terminal; the second capacitive element and the second switching element are connected in series and connected in parallel between the first output terminal and the second output terminal; the first diode element is connected in series between the first capacitive element and the second capacitive element.

Furthermore, the power factor correcting unit further has a second diode element, the first switching element has a first terminal and a second terminal, the second diode element is connected in parallel between the first terminal and the second terminal of the first switching element. Furthermore, the power factor correcting unit has a first connection state and a second connection state, when the power factor correcting unit is in the first connection state, the first switching element and the second switching element are in an off state or in an on state, based on a sine wave grid angle; when the power factor correcting unit is in the second connection state, the first switching element and the second switching element are in an on state.

Furthermore, the power factor correcting unit has a first connection state and a second connection state, when the power factor correcting unit is in the first connection state, the first switching element and the second switching element are in an on state; when the power factor correcting unit is in the second connection state, the first switching element and the second switching element are in an off state.

Furthermore, the first capacitive element has a positive terminal and a negative terminal, the second capacitive element has a positive terminal and a negative terminal, the first diode element has a positive terminal and a negative terminal; the positive terminal of the first capacitive element is connected to the first output terminal, the negative terminal of the first capacitive element is connected to one terminal of the first switching element, the other terminal of the first switching element is connected to the second output terminal, the negative terminal of the second capacitive element is connected to the second output terminal, the positive terminal of the second capacitive element is connected to one terminal of the second switching element, the other terminal of the second switching element is connected to the first output terminal, the positive terminal of the first diode element is connected to the negative terminal of the first capacitive element, the negative terminal of the first diode element is connected to the positive terminal of the first capacitive element.

Furthermore, the control unit is also used for controlling the first switching element and the second switching element.

The present application also proposes a control method for a brushless motor control system, the brushless motor control system comprises: a power supply modulation system for providing DC power to a brushless motor; the power supply modulation system comprises: a rectifier unit and a power factor correcting unit, wherein the rectifier unit has a first input terminal, a second input terminal, a first output terminal, and a second output terminal, the first input terminal and the second input terminal are used for connecting to an AC power grid, the rectifier unit is used for converting AC power into DC power; the power factor correcting unit is connected in parallel between the first output terminal and the second output terminal; the power factor correcting unit comprises a first capacitive element, a second capacitive element, a first diode element, a first switching element, and a second switching element, the first capacitive element and the first switching element are connected in series and connected in parallel between the first output terminal and the second output terminal; the second capacitive element and the second switching element are connected in series and connected in parallel between the first output terminal and the second output terminal; the first diode element is connected in series between the first capacitive element and the second capacitive element; the control method comprises: when the brushless motor is in the first operating state, the first switching element and the second switching element may be turned off; when the brushless motor is in the second operating state, the first switching element and the second switching element may be turned on. Based on the operating state of the brushless motor, the power supply modulation system switches its working mode, so that the brushless motor exhibits smaller phase current spike during low-speed and high-torque operation, thereby guaranteeing output torque and reducing copper loss in the motor. During high-speed and high-power operation, the brushless motor achieves a high power factor.

Furthermore, the first operating state is a high-speed operating state, the second operating state is a low-speed operating state.

The power supply modulation system, the brushless electric tool and the control method thereof, and the brushless motor control system and the control method thereof, as proposed in the present application, not only effectively increase the power factor, but also further switch the working mode of the power supply modulation system based on the operating state of the brushless motor. The brushless motor exhibits smaller phase current spike during low-speed operation, thereby guaranteeing output torque and reducing motor copper loss. During high-speed operation, the brushless motor exhibits a high power factor.

To make the aforementioned more comprehensible, several embodiments accompanied with drawings are described in detail as follows.

### BRIEF DESCRIPTION OF THE DRAWINGS

The accompanying drawings are included to provide a further understanding of the disclosure, and are incorporated in and constitute a part of this specification. The drawings illustrate exemplary embodiments of the disclosure and, together with the description, serve to explain the principles of the disclosure.

FIG. 1 is a system circuit block diagram of a high-voltage brushless electric tool according to an embodiment of the present application.

FIG. 2 is a system circuit block diagram of a high-voltage brushless electric tool according to an embodiment of the present application.

FIG. 3 is a circuit schematic diagram of a power supply modulation system according to an embodiment of the present application.

FIG. 4 is a circuit schematic diagram of a power supply modulation system according to another embodiment of the present application.

FIG. 5 is a circuit schematic diagram of a power supply modulation system according to another embodiment of the present application.

FIG. 6 is a circuit schematic diagram of a power supply modulation system according to another embodiment of the present application.

FIG. 7 is a schematic diagram of a brushless motor according to one of the embodiments of the present application.

FIG. 8 is a schematic diagram of the back electromotive force of a brushless motor according to one of the embodiments of the present application.

FIG. 9 is a schematic diagram comparing the current of the brushless motor shown in FIG. 7 during low-speed and high-torque operation.

FIG. 10 is a schematic diagram comparing the voltage of the brushless motor shown in FIG. 7 during low-speed and high-torque operation.

FIG. 11 is a schematic diagram comparing the phase current of the brushless motor shown in FIG. 7 during high-speed and high-power operation.

FIG. 12 is a schematic diagram comparing the output current of the rectifier unit of the brushless motor shown in FIG. 7 during high-speed and high-power operation.

FIG. 13 is a schematic diagram comparing the power factor of the power supply modulation system for the brushless motor shown in FIG. 7.

FIG. 14 is a schematic diagram comparing the copper loss of the brushless motor shown in FIG. 7.

### DESCRIPTION OF THE EMBODIMENTS

The technical solution of the present application will be elaborated more clearly and comprehensively below through the description of its preferred embodiments in conjunction with the drawings.

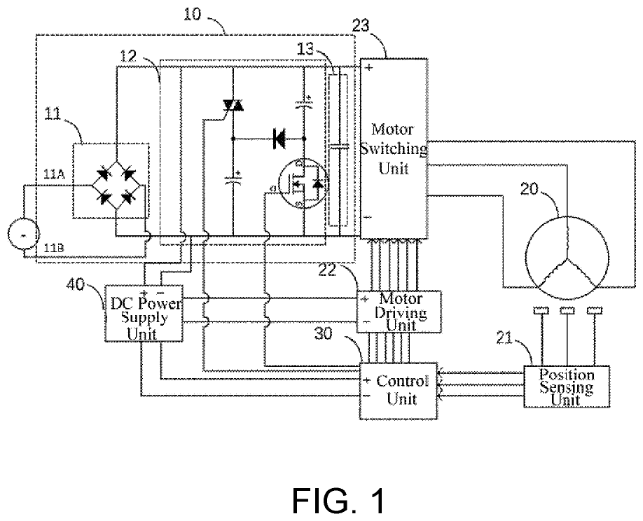

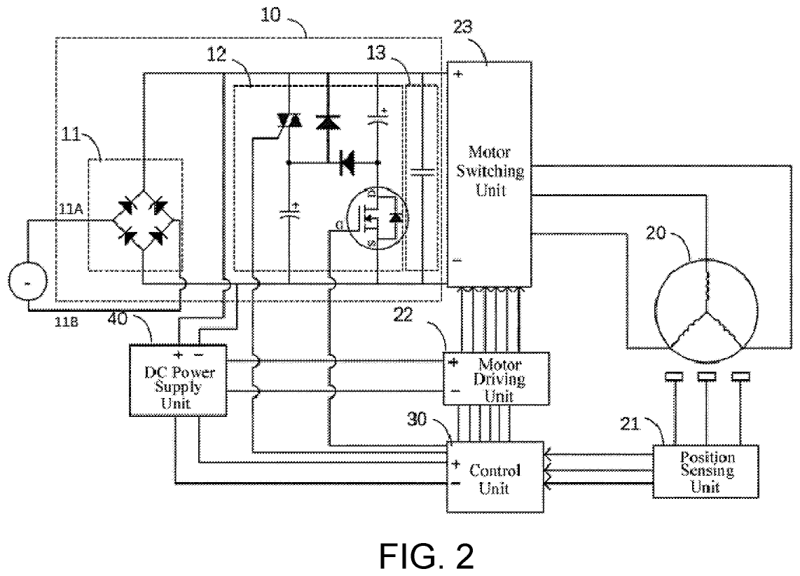

Some embodiments of the present application are shown in FIGS. 1-2. The power supply modulation system 10 includes: a rectifier unit 11 and a power factor correcting unit 12. The rectifier unit 11 has a first input terminal 11A, a second input terminal 11B, a first output terminal 11C, and a second output terminal 11D. The first input terminal 11A and the second input terminal 11B are used for connecting to the AC power grid, and the rectifier unit 11 is used for converting AC power into DC power. The power factor correcting unit 12 is connected in parallel between the first output terminal 11C and the second output terminal 11D; the power factor correcting unit 12 comprises a first capacitive element 121, a second capacitive element 122, a first diode element 123, a first switching element 124, and a second switching element 125. The first capacitive element 121 and the first switching element 124 are connected in series and are connected in parallel between the first output terminal 11C and the second output terminal 11D; the second capacitive element 122 and the second switching element 125 are connected in series and are connected in parallel between the first output terminal 11C and the second output terminal 11D; the first diode element 123 is connected in series between the first capacitive element 121 and the second capacitive element 122. The power supply modulation system proposed in the present application effectively improves the power factor and has low cost.

In some of the embodiments, as shown in FIG. 2, the power factor correcting unit 12 has a first connection state and a second connection state. When the power factor correcting unit 12 is in the first connection state, the first switching element 124 and the second switching element 125 are in an off state; when the power factor correcting unit 12 is in the second connection state, the first switching element 124 and the second switching element 125 are in an on state. This enables the connection state of the power factor correcting unit 12 to be selected according to the different operating states of the brushless motor. Consequently, the power factor is improved during high-speed operation of the brushless motor, while torque ripple is reduced during low-speed operation of the brushless motor, thereby ensuring output torque and reducing motor copper loss.

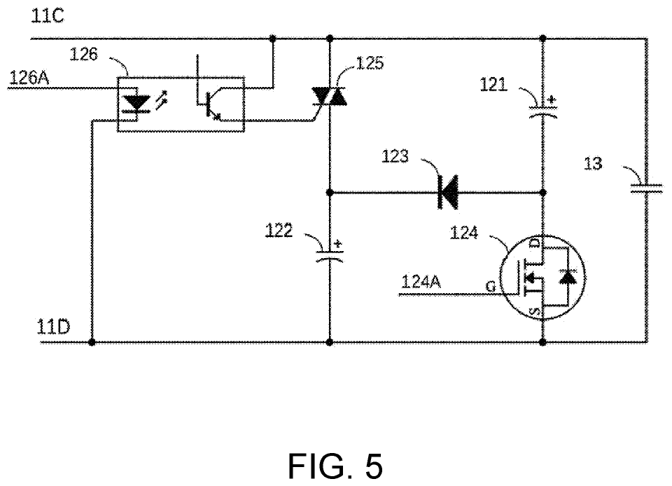

In some of the embodiments, as shown in FIGS. 5-6, the first capacitive element 121 has a positive pole and a negative pole, the second capacitive element 122 has a positive pole and a negative pole, the first diode element 123 has a positive pole and a negative pole. The positive pole of the first capacitive element 121 is connected to the first output terminal 11C, the negative pole of the first capacitive element 121 is connected to one terminal of the first switching element 124, the other terminal of the first switching element 124 is connected to the second output terminal 11D. The negative pole of the second capacitive element 122 is connected to the second output terminal 11D, the positive pole of the second capacitive element 122 is connected to one terminal of the second switching element 125, the other terminal of the second switching element 125 is connected to the first output terminal 11C. The positive pole of the first diode element 123 is connected to the negative pole of the first capacitive element 121, the negative pole of the first diode element 123 is connected to the positive pole of the first capacitive element 121.

In some alternative embodiments, the first switching element 124 has a control terminal 124A, the second switching element 125 has a control terminal 125A. By separately inputting a high level or a low level to the control terminal 124A or the control terminal 125A, the turning-on and turning-off of the first switching element 124 and the second switching element 125 are controlled, respectively.

In some alternative embodiments, the first switching element 124 or the second switching element 125 may also be driven by a switch driving unit. As shown in FIG. 5, in some embodiments, the second switching element 125 is driven and controlled to be turned on or turned off by the switch driving unit 126.

In the aforementioned embodiments, the capacitance values of the first capacitive element 121 and the second capacitive element 122 may be equal, or may be different. Preferably, the capacitance values of the first capacitive element 121 and the second capacitive element 122 are similar or equal.

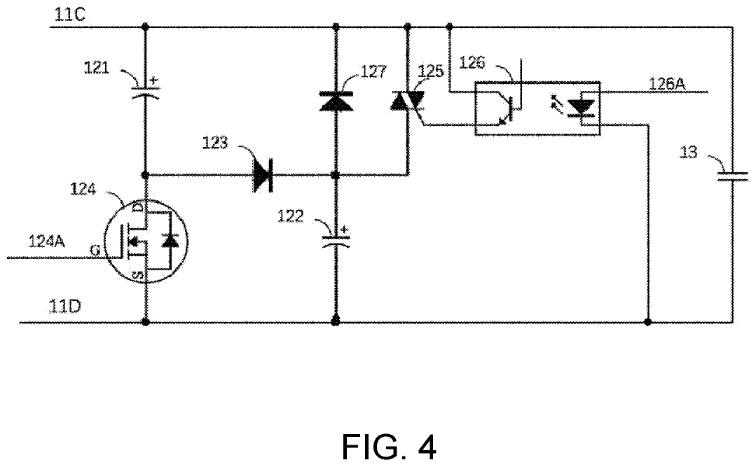

In some of the embodiments, as shown in FIGS. 2, 3 and 4, the power factor correcting unit 12 further comprises a second diode element 127. The second switching element 125 has a first terminal and a second terminal. The second diode element 127 is connected in parallel between the first terminal and second terminal of the second switching element 125. Furthermore, to achieve control optimization of the power supply modulation system, there is no need to control the first switching element 124 and second switching element 125 to be in an on state or in an off state based on the sine wave grid angle. It is only necessary to control the first switching element 124 and the second switching element 125 to be turned off at all times.

In some of the embodiments, the power supply modulation system 10 further includes a third capacitive element 13. The third capacitive element 13 is connected in parallel between the first output terminal 11C and the second output terminal 11D, for achieving high-frequency filtering.

In one specific embodiment, as shown in FIGS. 1, 5 or 6, when the brushless motor operates at low speed, a high-level signal is input to control terminals 126A and 124A, whereby the first switching element 124 and the second switching element 125 are turned on, the first capacitive element 121 and the second capacitive element 122 are charged and discharged in parallel. Thus, the power supply modulation system operates in a large capacitance mode, effectively increasing the torque output to the power load. When the brushless motor operates at high speed, at sine wave grid angles of 150° and 330°, a high-level signal is input to control terminals 126A and 124A. The first switching element 124 and the second switching element 125 are turned on, and the first capacitive element 121 and the second capacitive element 122 are discharged in parallel. At sine wave grid angles of 180° and 360°, a low-level signal is input to control terminals 126A and 124A. The first switching element 124 and the second switching element 125 are turned off, the first capacitive element 121 and the second capacitive element 122 are charged in series. Thus, the power supply modulation system operates in a power factor compensation mode, which improves the power factor of the system. Wherein, the first capacitive element 121 and the second capacitive element 122 are selected to have the same capacitive specification, with a capacitance value of 22 uF~440 uF. In some alternative embodiments, the first capacitive element 121 and the second capacitive element 122 may have capacitance values of 47 uF, 68 uF, 82 uF, or 150 uF, etc., with a withstand voltage of 400V/450V. The third capacitive element is a CBB capacitor with a capacitance value less than 10 uF. In some alternative embodiments, the third capacitive element has a value of 2.2 uf and a withstand voltage of 450V. Of course, for those skilled in the art, other capacitance values or withstand voltage values that meet the requirements are also acceptable, and will not be further repeated here.

In another specific embodiment, as shown in FIG. 2~4, when the brushless motor operates at low speed, a high-level signal is input to control terminals 126A and 124A, whereby the first switching element 124 and the second switching element 125 are turned on, and the first capacitive element 121 and the second capacitive element 122 are charged and discharged in parallel. Thus, the power supply modulation system operates in a large capacitance mode, effectively increasing the torque output to the power load. When the brushless motor operates at high speed, a low-level signal is input to control terminals 126A and 124A, whereby the first switching element 124 and the second switching element 125 are turned off, and the first capacitive element 121 and the second capacitive element 122 are charged in series and discharged in parallel. Thus, the power supply modulation system operates in a power factor compensation mode, enhancing the power factor of the power supply modulation system. Wherein, the first capacitive element 121 and the second capacitive element 122 are selected to have the same capacitive specification, with a capacitance value of 22 uF~440 uF. In some alternative embodiments, the first capacitive element 121 and the second capacitive element 122 may have capacitance values of 47 uF, 68 uF, 82 uF, or 150 uF, etc., with a withstand voltage of 400V/450V. The third capacitive element is a CBB capacitor with a capacitance value less than 10uF. In some alternative implementations, the third capacitive element has a value of 2.2 uf and a withstand voltage of 450V. Of course, for those skilled in the art, other capacitance values or withstand voltage values that meet the requirements are also acceptable, and will not be further repeated here.

Other embodiments of the present application are shown in FIG. 1~2. A brushless electric tool comprising: a brushless motor 20, provided with a position sensing unit 21; a power supply modulation system 10 for providing DC power to the brushless motor 20; a control unit 30 for providing a control signal to control the brushless motor 20; a motor driving unit 22 for receiving the control signal from the control unit 30 and sending a drive signal to drive the brushless motor 20 based on the control signal; and a motor switching unit 23 for receiving the drive signal from the motor driving unit 22 and switching the connection between the power supply modulation system 10 and the brushless motor 20; The power supply modulation system 10 includes: a rectifier unit 11 and a power factor correcting unit 12, wherein the rectifier unit 11 has a first input terminal 11A, a second input terminal 11B, a first output terminal 11C, and a second output terminal 11D. The first input terminal 11A and the second input terminal 11B are used for connecting to the AC power grid, and the rectifier unit 11 is used for converting AC power into DC power. The power factor correcting unit 12 is connected in parallel between the first output terminal 11C and the second output terminal 11D; the power factor correcting unit 12 comprises a first capacitive element 121, a second capacitive element 122, a first diode element 123, a first switching element 124, and a second switching element 125. The first capacitive element 121 and the first switching element 124 are connected in series and are connected in parallel between the first output terminal 11C and the second output terminal 11D; the second capacitive element 122 and the second switching element 125 are connected in series and are connected in parallel between the first output terminal 11C and the second output terminal 11D; the first diode element 123 is connected in series between the first capacitive element 121 and the second capacitive element 122. The brushless motor power supply modulation system in the present embodiment effectively improves the power factor and has low cost.

In some embodiments, as shown in FIG. 2, the power factor correcting unit 12 has a first connection state and a second connection state. When the power factor correcting unit 12 is in the first connection state, the first switching element 124 and the second switching element 125 are in an off state; when the power factor correcting unit 12 is in the second connection state, the first switching element 124 and the second switching element 125 are in an on state. This enables the connection state of the power factor correcting unit 12 to be selected according to the different operating states of the brushless motor. Consequently, the power factor is improved during high-speed operation of the brushless motor, while torque ripple is reduced during low-speed operation of the brushless motor, thereby ensuring output torque and reducing motor copper loss.

In some of the embodiments, as shown in FIGS. 1, 5 and 6, the first capacitive element 121 has a positive pole and a negative pole, the second capacitive element 122 has a positive pole and a negative pole, the first diode element 123 has a positive pole and a negative pole. The positive pole of the first capacitive element 121 is connected to the first output terminal 11C, the negative pole of the first capacitive element 121 is connected to one terminal of the first switching element 124, the other terminal of the first switching element 124 is connected to the second output terminal 11D. The negative pole of the second capacitive element 122 is connected to the second output terminal 11D, the positive pole of the second capacitive element 122 is connected to one terminal of the second switching element 125, the other terminal of the second switching element 125 is connected to the first output terminal 11C. The positive pole of the first diode element 123 is connected to the negative pole of the first capacitive element 121, the negative pole of the first diode element 123 is connected to the positive pole of the first capacitive element 121.

In some alternative embodiments, the first switching element 124 has a control terminal 124A, the second switching element 125 has a control terminal 125A. By separately inputting a high level or a low level to the control terminal 124A or the control terminal 125A, the turning-on and turning-off of the first switching element 124 and the second switching element 125 are controlled, respectively.

In some alternative embodiments, the first switching element 124 or the second switching element 125 may also be driven by a switch driving unit. As shown in FIG. 5, in some embodiments, the second switching element 125 is driven and controlled to be turned on or turned off by the switch driving unit 126.

In the aforementioned embodiments, the capacitance values of the first capacitive element 121 and the second capacitive element 122 may be equal, or may be different. Preferably, the capacitance values of the first capacitive element 121 and the second capacitive element 122 are similar or equal.

In some of the embodiments, as shown in FIG. 2~4, the power factor correcting unit 12 further comprises a second diode element 127, the second switching element 125 has a first terminal and a second terminal, and the second diode element 127 is connected in parallel between the first terminal and the second end of the second switching element 125. Furthermore, control optimization of the power supply modulation system is achieved.

In some of the embodiments, the power supply modulation system 10 further includes a third capacitive element 13. The third capacitive element 13 is connected in parallel between the first output terminal 11C and the second output terminal 11D, for achieving high-frequency filtering.

In some of the embodiments, the control unit 30 is also used to control the first switching element 124 and the second switching element 125.

In the above embodiments as proposed in the present application, the control unit 30 may be a single-chip microcomputer or other integrated control circuits; The motor driving unit 22 may be an independent drive control circuit, or may share an integrated control circuit with the control unit 30; The motor switching unit 23 is an inverter integrated circuit; The position sensing unit 21 may be a sensing detection element, or a module that performs position detection via software programs stored in a hardware element, or a module that performs position detection through software programs stored in a hardware element in cooperation with an electronic element. The above is easy for those skilled in the art to think of, and will not be repeated here.

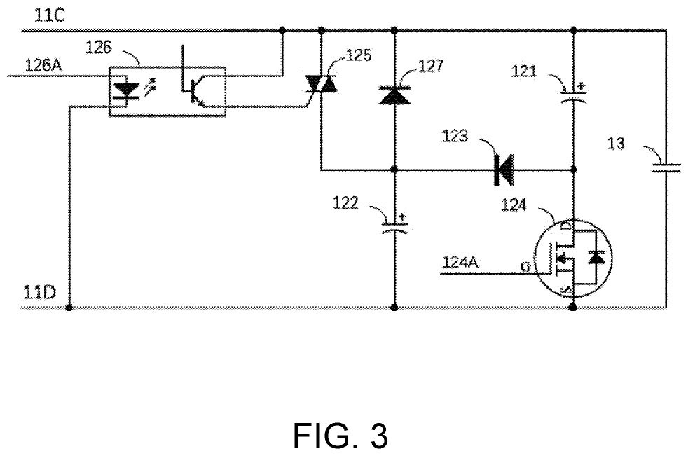

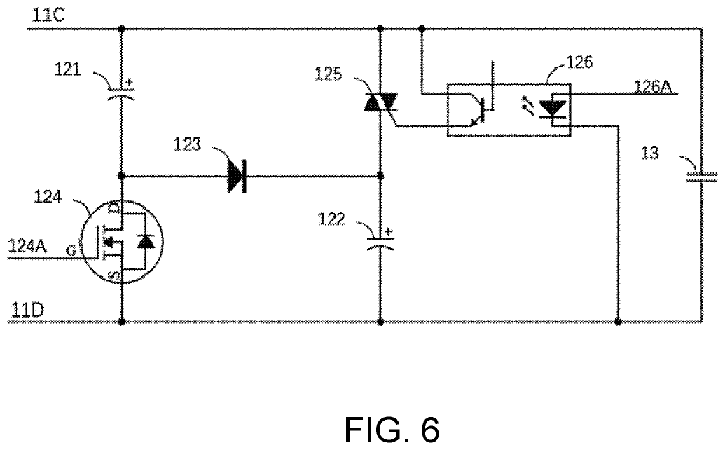

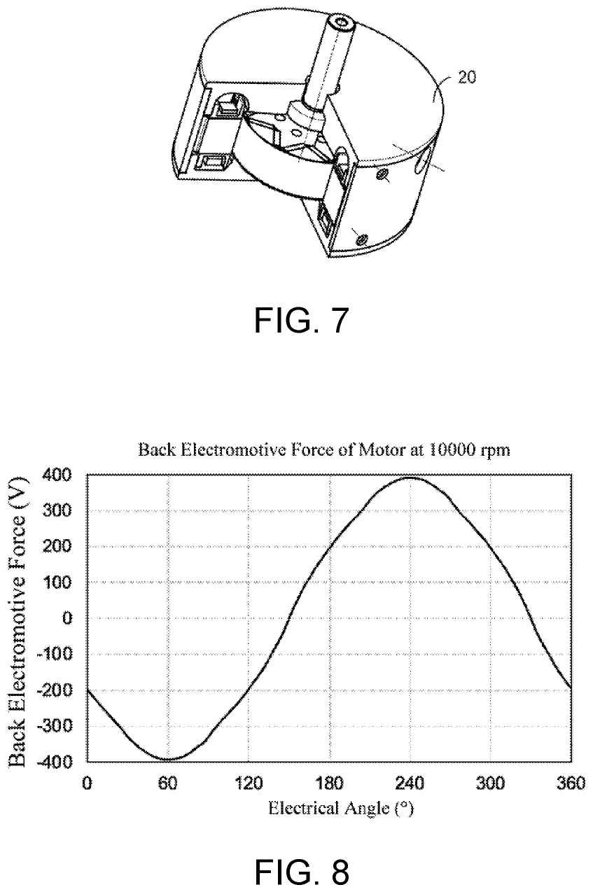

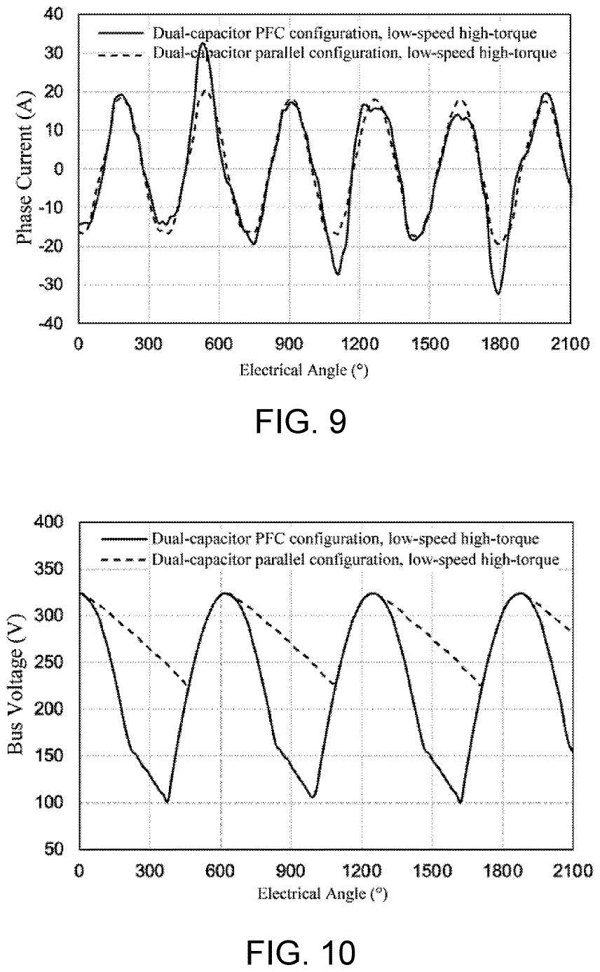

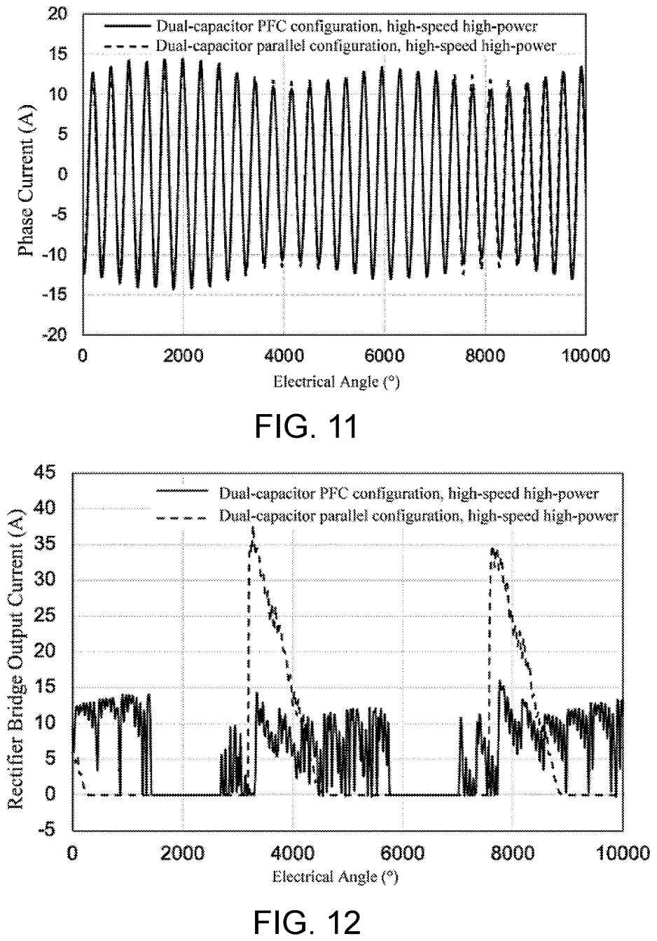

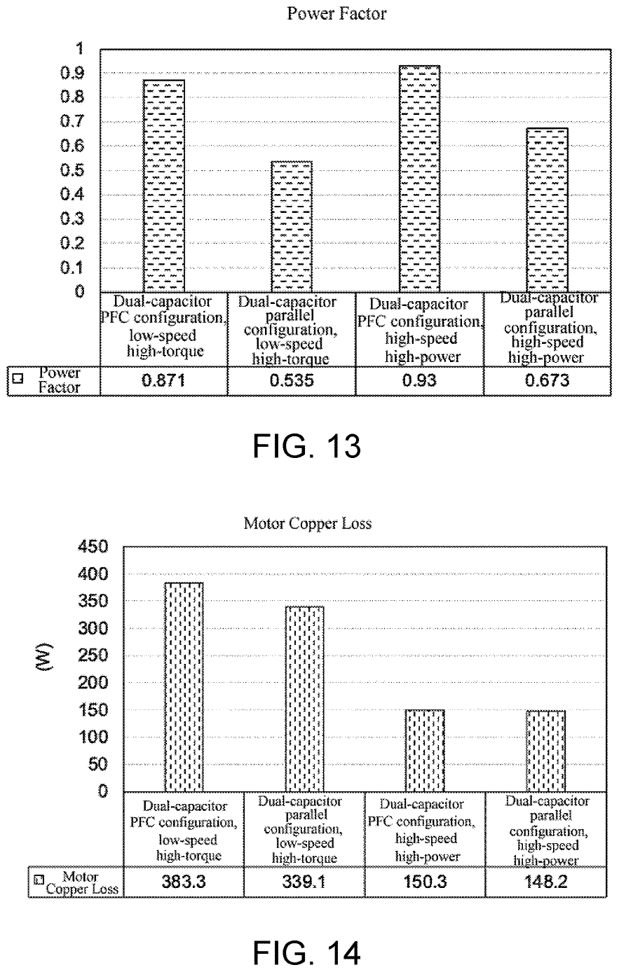

In one specific embodiment, as shown in FIG. 7, the brushless motor 20 has a stator with an outer diameter of 135 mm, and a stack thickness of 13 mm, and the brushless motor 20 has an eight-pole, twelve-slot structure. The phase resistance of the brushless motor 20 is 0.48 mΩ, and the d-axis inductance is 3.25 mH, the q-axis inductance is 4.77 mH. The line back electromotive force at 10000 rpm (revolutions per minute) is shown in FIG. 8. The power supply modulation circuit as shown in FIG. 3 is configured. The first capacitive element 121 and the second capacitive element 122 are both 220 uF electrolytic capacitors. When the first switching element 124 and the second switching element 125 are turned off, the first capacitive element 121 and the second capacitive element 122 are connected in a series state while charging, and are connected in a parallel state while discharging. That is, the power supply modulation system 10 is in a power factor compensation mode, the brushless motor 20 is controlled at a low speed of 2600 rpm. When the current is 20 A and the torque angle is 10 °, the output rotation speed is 5 Nm. During operation of the brushless motor, the current is shown as the solid line in FIG. 9, and the bus voltage is shown as the solid line in FIG. 10. When the first switching element 124 and the second switching element 125 are both turned on, the first capacitive element 121 and the second capacitive element 122 are connected in parallel. That is, the power supply modulation system 10 is in a large capacitance mode, the brushless motor 20 is controlled at a low and constant speed of 2600 rpm. When the current is 20 A and the torque angle is 10°, the resulting output rotation speed is also 5 Nm. During operation of the brushless motor, the current is shown as the dashed line in FIG. 9, and the bus voltage is shown as the dashed line in FIG. 10. As shown in FIG. 9 and FIG. 10, when the power supply modulation system 10 is in the large capacitance mode, the bus voltage fluctuation is small when the motor operates at low-speed and large-torque, so that the phase current fluctuation of the motor is small and the effective value of the current is smaller, which is not only conducive to improving the stability of the motor output torque, but also may reduce the copper loss of the motor and the current stress of the power transistor. With the same configuration of the power supply modulation circuit as shown in FIG. 3, the first capacitive element 121 and the second capacitive element 122 are both 220 uF electrolytic capacitors. When the first switching element 124 and the second switching element 125 are turned off, the first capacitive element 121 and the second capacitive element 122 are connected in a series state when charging and are connected in a parallel state when discharging. That is, the power supply modulation system 10 is in a power factor compensation mode, the brushless motor 20 is controlled at a high and constant speed of 18000 rpm, the motor d-axis current is negative 12 A, and the motor q-axis current is 2 A, the resulting input power is 1500 W. During operation of the brushless motor, the phase current is shown as the solid line in FIG. 11, and the output current of the rectifier unit 11 is shown as the solid line in FIG. 12. When the first switching element 124 and the second switching element 125 are both turned on, the first capacitive element 121 and the second capacitive element 122 are connected in parallel. that is, the power supply modulation system 10 is in the large capacitance mode, the brushless motor 20 is controlled at a high and constant speed of 18000 rpm, the motor d-axis current is negative 12 A, the motor q-axis current is 2 A, the resulting input power is 1500 W. During operation of the brushless motor, the phase current is shown as the dashed line in FIG. 11, the output current of the rectifier unit 11 is shown as the solid line in FIG. 12. As shown in FIG. 11 and FIG. 12, when the power supply modulation system 10 is in the power factor compensation mode, the phase current of the brushless motor 20 during high-speed operation is not significantly different from that when the power supply modulation system 10 is in the large capacitance mode. However, the amplitude of the output current of the rectifier unit 11 is much smaller. That is, when the motor is operating at a high speed, the power factor of the brushless motor power supply modulation system 10 can be significantly improved. As shown in the power factor comparison diagram of the brushless motor 20 in FIG. 13 and the motor copper loss comparison diagram of the brushless motor 20 in FIG. 14, when the power supply modulation system 10 is in the power factor compensation mode, the power factor of the brushless motor during high-speed operation can be significantly improved. When the power supply modulation system 10 is in the large capacitance mode, the copper loss of the brushless motor during low-speed operation can be significantly reduced. That is, as in the above embodiments, the power supply modulation system 10 switches to the power factor compensation mode when the brushless motor is operating at high speed and switches to the large capacitance mode when the brushless motor is operating at low speed. This not only enables the brushless motor to have a high power factor during high-speed operation but also enables the brushless motor to have smaller phase current spikes during low-speed operation, thus ensuring the output torque.

In another embodiment of the present application, a control method for a brushless electric tool, as shown in FIG. 1~2, is provided. The brushless electric tool comprises: a brushless motor 20 and a power supply modulation system 10 for providing DC power to the brushless motor 20; the power supply modulation system 10 includes: a rectifier unit 11 and a power factor correcting unit 12, wherein the rectifier unit 11 has a first input terminal 11A, a second input terminal 11B, a first output terminal 11C, and a second output terminal 11D. The first input terminal 11A and the second input terminal 11B are used for connecting to the AC power grid, and the rectifier unit 11 is used for converting AC power into DC power; The power factor correcting unit 12 is connected in parallel between the first output terminal 11C and the second output terminal 11D; the power factor correcting unit 12 comprises a first capacitive element 121, a second capacitive element 122, a first diode element 123, a first switching element 124, and a second switching element 125. The first capacitive element 121 and the first switching element 124 are connected in series and are connected in parallel between the first output terminal 11C and the second output terminal 11D; the second capacitive element 122 and the second switching element 125 are connected in series and are connected in parallel between the first output terminal 11C and the second output terminal 11D; the first diode element 123 is connected in series between the first capacitive element 121 and the second capacitive element 122. The control method for the brushless electric tool comprises: when the brushless motor 20 is in the first operating state, the first switching element 124 and the second switching element 125 may be turned off; when the brushless motor 20 is in the second operating state, the first switching element 121 and the second switching element 122 may be turned on. This enables the connection state of the power factor correcting unit 12 to be selected according to the different operating states of the brushless motor; Consequently, the brushless motor operates in the power factor compensation mode to improve the power factor during high-speed operation of the brushless motor, while torque ripple is reduced during low-speed operation of the brushless motor, thereby ensuring output torque and reducing motor copper loss.

In some alternative embodiments, the first operating state is a high-speed operating state, and the second operating state is a low-speed operating state.

In one specific embodiment, as shown in FIG. 1, when the brushless motor operates at low speed, a high-level signal is input to control terminals 126A and 124A, whereby the first switching element 124 and the second switching element 125 are turned on, the first capacitive element 121 and the second capacitive element 122 are charged and discharged in parallel. Thus, the power supply modulation system operates in a large capacitance mode, effectively increasing the torque output to the power supply load. When the brushless motor operates at high speed, at sine wave grid angles of 150°and 330°, a high-level signal is input to control terminals 126A and 124A. The first switching element 124 and the second switching element 125 are turned on, and the first capacitive element 121 and the second capacitive element 122 are discharged in parallel. At sine wave grid angles of 180°and 360°, a low-level signal is input to control terminals 126A and 124A. The first switching element 124 and the second switching element 125 are turn off, the first capacitive element 121 and the second capacitive element 122 are charged in series. Thus, the power supply modulation system operates in a power factor compensation mode, which improves the power factor of the system.

In another specific embodiment, as shown in FIG. 2, when the brushless motor operates at low speed, a high-level signal is input to control terminals 126A and 124A, whereby the first switching element 124 and the second switching element 125 are turned on, and the first capacitive element 121 and the second capacitive element 122 are charged and discharged in parallel. Thus, the power supply modulation system operates in a large capacitance mode, effectively increasing the torque output to the power supply load. When the brushless motor operates at high speed, a low-level signal is input to control terminals 126A and 124A, whereby the first switching element 124 and the second switching element 125 are turned off, and the first capacitive element 121 and the second capacitive element 122 are charged in series and discharged in parallel. Thus, the power supply modulation system operates in a power factor compensation mode, enhancing the power factor of the power supply modulation system.

Other embodiments of the present application are shown in FIG. 1~2. A brushless motor control system comprises: a power supply modulation system 10 for providing DC power to a brushless motor 20; a control unit 30 for providing a control signal to control the brushless motor 20; motor driving unit 22 for receiving the control signal from the control unit 30 and sending a drive signal to drive the brushless motor 20 based on the control signal; and a motor switching unit 23 for receiving the drive signal from the motor driving unit 22 and switching the connection between the power supply modulation system 10 and the brushless motor 20; The power supply modulation system 10 includes: a rectifier unit 11 and a power factor correcting unit 12, wherein the rectifier unit 11 has a first input terminal 11A, a second input terminal 11B, a first output terminal 11C, and a second output terminal 11D. The first input terminal 11A and the second input terminal 11B are used for connecting to the AC power grid, and the rectifier unit 11 is used for converting AC power into DC power. The power factor correcting unit 12 is connected in parallel between the first output terminal 11C and the second output terminal 11D; the power factor correcting unit 12 comprises a first capacitive element 121, a second capacitive element 122, a first diode element 123, a first switching element 124, and a second switching element 125. The first capacitive element 121 and the first switching element 124 are connected in series and are connected in parallel between the first output terminal 11C and the second output terminal 11D; the second capacitive element 122 and the second switching element 125 are connected in series and are connected in parallel between the first output terminal 11C and the second output terminal 11D; the first diode element 123 is connected in series between the first capacitive element 121 and the second capacitive element 122. The brushless motor power supply modulation system in the present embodiment effectively improves the power factor and has low cost.

In some embodiments, as shown in FIG. 2, the power factor correcting unit 12 has a first connection state and a second connection state. When the power factor correcting unit 12 is in the first connection state, the first switching element 124 and the second switching element 125 are in an off state; when the power factor correcting unit 12 is in the second connection state, the first switching element 124 and the second switching element 125 are in an on state. This enables the connection state of the power factor correcting unit 12 to be selected according to the different operating states of the brushless motor. Consequently, the power factor is improved during high-speed operation of the brushless motor, while torque ripple is reduced during low-speed operation of the brushless motor, thereby ensuring output torque and reducing motor copper loss.

In some implementations, the brushless motor 20 has a first operating state and a second operating state. When the brushless motor 20 is in the first operating state, the power factor correcting unit 12 is in a first connection state; when the brushless motor 20 is in the second operating state, the power factor correcting unit 12 is in a second connection state. Based on the operating state of the brushless motor, the power supply modulation system switches its working mode, so that the brushless motor exhibits smaller phase current spikes during low-speed and high-torque operation, thereby guaranteeing output torque and reducing copper loss in the motor. During high-speed and high-power operation, the brushless motor achieves a high power factor.

In some preferable embodiments, the first operating state is a high-speed operating state, and the second operating state is a low-speed operating state.

In some of the embodiments, as shown in FIGS. 1, 5 and 6, the first capacitive element 121 has a positive pole and a negative pole, the second capacitive element 122 has a positive pole and a negative pole, the first diode element 123 has a positive pole and a negative pole. The positive pole of the first capacitive element 121 is connected to the first output terminal 11C, the negative pole of the first capacitive element 121 is connected to one terminal of the first switching element 124, the other terminal of the first switching element 124 is connected to the second output terminal 11D. The negative pole of the second capacitive element 122 is connected to the second output terminal 11D, the positive pole of the second capacitive element 122 is connected to one terminal of the second switching element 125, the other terminal of the second switching element 125 is connected to the first output terminal 11C. The positive pole of the first diode element 123 is connected to the negative pole of the first capacitive element 121, the negative pole of the first diode element 123 is connected to the positive pole of the first capacitive element 121.

In some alternative embodiments, the first switching element 124 has a control terminal 124A, the second switching element 125 has a control terminal 125A. By separately inputting a high level or a low level to the control terminal 124A or the control terminal 125A, the turning-on and turning-off of the first switching element 124 and the second switching element 125 are controlled, respectively. In the embodiments as shown in FIGS. 1, 5 and 6, when the electric tool is in the high-speed operating state, the first switching element 124 and the second switch 125 are in an on state or in an off state, which needs to be controlled based on the sine wave grid angle, here it is not repeated. When the electric tool is in the high-speed operating state, the first switching element 124 and the second switch 125 are in an on state, realizing the switching of the operating mode of the power supply modulation system based on the operating state of the brushless motor, so that the brushless motor has smaller phase current spikes when operating at low-speed and high-torque, thus ensuring the output torque, reducing the motor copper loss, and having high power factor when operating at high-speed and high-power.

In some alternative embodiments, the first switching element 124 or the second switching element 125 may also be driven by a switch driving unit. As shown in FIG. 5, in some embodiments, the second switching element 125 is driven and controlled to be turned on or turned off by the switch driving unit 126.

In the aforementioned embodiments, the capacitance values of the first capacitive element 121 and the second capacitive element 122 may be equal, or may be different. Preferably, the capacitance values of the first capacitive element 121 and the second capacitive element 122 are similar or equal.

In some of the embodiments, as shown in FIG. 2~4, the power factor correcting unit 12 further comprises a second diode element 127, the second switching element 125 has a first terminal and a second terminal, and the second diode element 127 is connected in parallel between the first terminal and the second end of the second switching element 125. Furthermore, control optimization of the power supply modulation system is achieved.

In some of the embodiments, the power supply modulation system 10 further includes a third capacitive element 13. The third capacitive element 13 is connected in parallel between the first output terminal 11C and the second output terminal 11D, for achieving high-frequency filtering.

In some of the embodiments, the control unit 30 is also used to control the first switching element 124 and the second switching element 125.

In another embodiment of the present application, a control method for the brushless motor control system, as shown in FIG. 1~2, is provided, wherein the brushless motor control system comprises: a power supply modulation system 10 for providing DC power to a brushless motor 20; the power supply modulation system 10 comprises: a rectifier unit 11 and a power factor correcting unit 12, wherein the rectifier unit 11 has a first input terminal 11A, a second input terminal 11B, a first output terminal 11C, and a second output terminal 11D. The first input terminal 11A and the second input terminal 11B are used for connecting to the AC power grid, and the rectifier unit 11 is used for converting AC power into DC power; The power factor correcting unit 12 is connected in parallel between the first output terminal 11C and the second output terminal 11D; the power factor correcting unit 12 comprises a first capacitive element 121, a second capacitive element 122, a first diode element 123, a first switching element 124, and a second switching element 125. The first capacitive element 121 and the first switching element 124 are connected in series and are connected in parallel between the first output terminal 11C and the second output terminal 11D; the second capacitive element 122 and the second switching element 125 are connected in series and are connected in parallel between the first output terminal 11C and the second output terminal 11D; the first diode element 123 is connected in series between the first capacitive element 121 and the second capacitive element 122. The control method for the brushless electric tool comprises: when the brushless motor 20 is in the first operating state, the first switching element 124 and the second switching element 125 may be turned off; when the brushless motor 20 is in the second operating state, the first switching element 121 and the second switching element 122 may be turned on. This enables the connection state of the power factor correcting unit 12 to be selected according to the different operating states of the brushless motor. Consequently, the power factor is improved during high-speed operation of the brushless motor, while torque ripple is reduced during low-speed operation of the brushless motor, thereby ensuring output torque and reducing motor copper loss.

In one specific embodiment, as shown in FIG. 1, when the brushless motor operates at low speed, a high-level signal is input to control terminals 126A and 124A, whereby the first switching element 124 and the second switching element 125 are turned on, the first capacitive element 121 and the second capacitive element 122 are charged and discharged in parallel. Thus, the power supply modulation system operates in a large capacitance mode, effectively increasing the torque output to the power supply load. When the brushless motor operates at high speed, at sine wave grid angles of 150° and 330°, a high-level signal is input to control terminals 126A and 124A, whereby the first switching element 124 and the second switching element 125 are turned on, the first capacitive element 121 and the second capacitive element 122 are discharged in parallel. At sine wave grid angles of 180° and 360°, a low-level signal is input to control terminals 126A and 124A, whereby the first switching element 124 and the second switching element 125 are turned off, the first capacitive element 121 and the second capacitive element 122 are charged in series. Thus, the power supply modulation system operates in a power factor compensation mode, which improves the power factor of the system.

In another specific embodiment, as shown in FIG. 2, when the brushless motor operates at low speed, a high-level signal is input to control terminals 126A and 124A, whereby the first switching element 124 and the second switching element 125 are turned on, and the first capacitive element 121 and the second capacitive element 122 are charged and discharged in parallel. Thus, the power supply modulation system operates in a large capacitance mode, effectively increasing the torque output to the power supply load. When the brushless motor operates at high speed, a low-level signal is input to control terminals 126A and 124A, whereby the first switching element 124 and the second switching element 125 are turned off, and the first capacitive element 121 and the second capacitive element 122 are charged in series and discharged in parallel. Thus, the power supply modulation system operates in a power factor compensation mode, enhancing the power factor of the power supply modulation system.

In some alternative embodiments, the first operating state is a high-speed operating state, and the second operating state is a low-speed operating state.

In some of the aforementioned alternative embodiments, the control unit 30 may directly control the first switching element 121 and the second switching element 122. In other alternative embodiments, the control unit 30 may control the first switching element 121 and the second switching element 122 through the switch driving unit 133, which is easy for those skilled in the art to think of, and will not be repeated here.

In some of the aforementioned preferable embodiments, the low-speed operating state refers to a rotation speed that is 20%~30% lower than the maximum rotation speed of the brushless motor, and the high-speed operation state refers to a rotation speed that is 20%~30% higher than the maximum rotation speed of the brushless motor. Of course, for those skilled in the art, the low-speed and high-speed states may also be defined by other criteria according to the load characteristics of different brushless electric tools., and the determination of the rotation speed can also be made by judging current or voltage or other electrical signals, which is not limited here.

In the aforementioned embodiments, the first switching element 124 or the second switching element 125 may be a thyristor, or a MOSFET, an IGBT or gallium nitride, which is not limited here. Of course, it may be other switching elements known to those skilled in the art, which is not repeated here. As shown in FIG. 5~6, when the first switching element 124 and the second switching element 125 are turned off, the second switching element 125 is equivalent to a diode whose positive pole is connected to the first output terminal 11C and negative pole is connected to the second output terminal 11D, the first switching element 124 is equivalent to a diode whose positive pole is connected to the negative pole of the first capacitive element 121 and negative pole is connected to the second output terminal 11D, so that the power factor correcting unit can work in the power factor compensation mode. Therefore, in some of the other alternative embodiments, if the element selected as the first switching element 124 or the second switching element 125 does not inherently behave as a diode connected in series in the circuit when turned off, the first switching element 124 or the second switching element 125 needs to be connected with a diode in parallel.

In the aforementioned embodiments, the brushless electric tool is a high-voltage brushless electric tool, which may be a high-voltage brushless angle grinder, a high-voltage brushless electric drill, a high-voltage brushless circular saw, etc., as well as high-voltage brushless household appliances such as a juicer, a blender, and a bread maker. They can also be high-voltage brushless electric tools for household or industrial uses, such as a vacuum cleaner, a floor sweeper, and a high-voltage cleaner, which are not limited herein.

The above detailed description merely depicts the preferred implementations of the present application, rather than limits the scope of protection of the present application. Without departing from the design concept and spirit of the present application, various modifications, substitutions, and improvements made by ordinary technicians in the art based on the textual description and drawings provided by the present application should fall within the scope of protection of the present application. The scope of protection of the present application is determined by its claims.

What is claimed is:

1. A power supply modulation system, comprising:
a rectifier unit, having a first input terminal, a second input terminal, a first output terminal, and a second output terminal; the first input terminal and the second input terminal are used for connecting to an alternating current (AC) power grid, the rectifier unit is used for converting an AC power into a direct current (DC) power; and
a power factor correcting unit, connected in parallel between the first output terminal and the second output terminal;
wherein the power factor correcting unit comprises a first capacitive element, a second capacitive element, a first diode element, a first switching element, and a second switching element, the first capacitive element and the first switching element are connected in series and connected in parallel between the first output terminal and the second output terminal; the second capacitive element and the second switching element are connected in series and connected in parallel between the first output terminal and the second output terminal; the first diode element is arranged in series between the first capacitive element and the second capacitive element.

2. The power supply modulation system according to claim 1, wherein a capacitance of the first capacitive element is equal to a capacitance of the second capacitive element.

3. The power supply modulation system according to claim 1, wherein the power factor correcting unit further comprises a second diode element, the second switching element has a first terminal and a second terminal, the second diode element is connected in parallel between the first terminal and the second terminal of the second switching element.

4. The power supply modulation system according to claim 3, wherein the power factor correcting unit has a first connection state and a second connection state, when the power factor correcting unit is in the first connection state, the first switching element and the second switching element are in an off state; when the power factor correcting unit is in the second connection state, the first switching element and the second switching element are in an on state.

5. The power supply modulation system according to claim 1, wherein the power factor correcting unit has a first connection state and a second connection state, when the power factor correcting unit is in the first connection state, the first switching element and the second switching element are in an off state or in an on state, based on a sine wave grid angle; when the power factor correcting unit is in the second connection state, the first switching element and the second switching element are in an on state.

6. A brushless electric tool, comprising:
a brushless motor, provided with a position sensing unit;
a power supply modulation system for providing DC power to the brushless motor;
a control unit for providing a control signal to control the brushless motor;
a motor driving unit for receiving the control signal from the control unit and sending a drive signal to drive the brushless motor based on the control signal; and
a motor switching unit for receiving the drive signal from the motor driving unit and switching a connection between the power supply modulation system and the brushless motor;
wherein the power supply modulation system comprises:
a rectifier unit, having a first input terminal, a second input terminal, a first output terminal, and a second output terminal; the first input terminal and the second input terminal are used for connecting to an alternating current (AC) power grid, the rectifier unit is used for converting an AC power into a direct current (DC) power; and
a power factor correcting unit, connected in parallel between the first output terminal and the second output terminal;
wherein the power factor correcting unit comprises a first capacitive element, a second capacitive element, a first diode element, a first switching element, and a second switching element, the first capacitive element and the first switching element are connected in series and connected in parallel between the first output terminal and the second output terminal; the second capacitive element and the second switching element are connected in series and connected in parallel between the first output terminal and the second output terminal; the first diode element is arranged in series between the first capacitive element and the second capacitive element.

7. The brushless electric tool according to claim 6, wherein the power factor correcting unit further comprises a second diode element, the first switching element has a first terminal and a second terminal, the second diode element is connected in parallel between the first terminal and the second terminal of the first switching element.

8. The brushless electric tool according to claim 7, wherein the power factor correcting unit has a first connection state and a second connection state, when the power factor correcting unit is in the first connection state, the first switching element and the second switching element are in an off state; when the power factor correcting unit is in the second connection state, the first switching element and the second switching element are in an on state.

9. The brushless electric tool according to claim 6, wherein the power factor correcting unit has a first connection state and a second connection state, when the power factor correcting unit is in the first connection state, the first switching element and the second switching element are in an off state or in an on state, based on a sine wave grid angle; when the power factor correcting unit is in the second connection state, the first switching element and the second switching element are in an on state.

10. The brushless electric tool according to claim 6, wherein the control unit is further used for controlling the first switching element and the second switching element.

11. A control method for a brushless electric tool, the brushless electric tool comprising:
a brushless motor and a power supply modulation system for providing a direct current (DC) power to the brushless motor; the power supply modulation system comprises:
a rectifier unit, having a first input terminal, a second input terminal, a first output terminal, and a second output terminal; the first input terminal and the second input terminal are used for connecting to an alternating current (AC) power grid, the rectifier unit is used for converting an AC power into a DC electrical power; and
a power factor correcting unit, connected in parallel between the first output terminal and the second output terminal;
wherein the power factor correcting unit comprises a first capacitive element, a second capacitive element, a first diode element, a first switching element, and a second switching element, the first capacitive element and the first switching element are connected in series and connected in parallel between the first output terminal and the second output terminal; the second capacitive element and the second switching element are connected in series and connected in parallel between the first output terminal and the second output terminal; the first diode element is arranged in series between the first capacitive element and the second capacitive element;
wherein the control method for the brushless electric tool comprises:
when the brushless motor is in a first operating state, the first switching element and the second switching element can be turned off;
when the brushless motor is in a second operating state, the first switching element and the second switching element can be turned on.

12. The control method for the brushless electric tool according to claim 11, wherein the first operating state is a first-speed operating state, and the second operating state is a second-speed operating state slower than the first-speed operating state.

13. A brushless motor control system, comprising:
a power supply modulation system for providing direct current (DC) power to a brushless motor;
a control unit for providing a control signal to control the brushless motor;
a motor driving unit for receiving the control signal from the control unit and sending a drive signal to drive the brushless motor based on the control signal; and
a motor switching unit for receiving the drive signal from the motor driving unit and switching a connection between the power supply modulation system and the brushless motor;
wherein the power supply modulation system comprises:
a rectifier unit, having a first input terminal, a second input terminal, a first output terminal, and a second output terminal; the first input terminal and the second input terminal are used for connecting to an alternating current (AC) power grid, the rectifier unit is used for converting an AC power into a DC power; and
a power factor correcting unit, connected in parallel between the first output terminal and the second output terminal;
wherein the power factor correcting unit comprises a first capacitive element, a second capacitive element, a first diode element, a first switching element, and a second switching element, the first capacitive element and the first switching element are connected in series and connected in parallel between the first output terminal and the second output terminal; the second capacitive element and the second switching element are connected in series and connected in parallel between the first output terminal and the second output terminal; the first diode element is arranged in series between the first capacitive element and the second capacitive element.

14. The brushless motor control system according to claim 13, wherein the power factor correcting unit further comprises a second diode element, the first switching element has a first terminal and a second terminal, the second diode element is connected in parallel between the first terminal and the second terminal of the first switching element.

15. The brushless motor control system according to claim 14, wherein the power factor correcting unit has a first connection state and a second connection state, when the power factor correcting unit is in the first connection state, the first switching element and the second switching element are in an off state; when the power factor correcting unit is in the second connection state, the first switching element and the second switching element are in an on state.

16. The brushless motor control system according to claim 13, wherein the power factor correcting unit has a first connection state and a second connection state, when the power factor correcting unit is in the first connection state, the first switching element and the second switching element are in an off state or in an on state, based on a sine wave grid angle; when the power factor correcting unit is in the second connection state, the first switching element and the second switching element are in an on state.

17. The brushless motor control system according to claim 13, wherein the control unit is further used for controlling the first switching element and the second switching element.

18. A control method for a brushless motor control system, the brushless motor control system comprises:
a power supply modulation system for providing direct current (DC) power to a brushless motor; the power supply modulation system comprises:
a rectifier unit, having a first input terminal, a second input terminal, a first output terminal, and a second output terminal; the first input terminal and the second input terminal are used for connecting to an alternating current (AC) power grid, the rectifier unit is used for converting an AC electrical energy into a DC electrical energy; and
a power factor correcting unit, connected in parallel between the first output terminal and the second output terminal;
wherein the power factor correcting unit comprises a first capacitive element, a second capacitive element, a first diode element, a first switching element, and a second switching element, the first capacitive element and the first switching element are connected in series and connected in parallel between the first output terminal and the second output terminal; the second capacitive element and the second switching element are connected in series and connected in parallel between the first output terminal and the second output terminal; the first diode element is arranged in series between the first capacitive element and the second capacitive element;
wherein, the control method comprising:
when the brushless motor is in a first operating state, the first switching element and the second switching element can be turned off;
when the brushless motor is in a second operating state, the first switching element and the second switching element can be turned on.

19. The control method according to claim 18, wherein the first operating state is a first-speed operating state, and the second operating state is a second-speed operating state slower than the first-speed operating state.
